(19) United States
(12) Patent Application Publication
(10) Pub. No.: US 2018/0287234 A1
(43) Pub. Date: Oct. 4, 2018

(54) INTEGRATED COOLING AND VENTING SYSTEM

(71) Applicant: Kitty Hawk Corporation, Mountain View, CA (US)

(72) Inventors: John Melack, Redwood City, CA (US); Thomas P. Muniz, Sunnyvale, CA (US); Nihal Murthy, San Francisco, CA (US)

(21) Appl. No.: 15/471,965

(22) Filed: Mar. 28, 2017

(51) Int. Cl. H01M 10/6566; B64D 27/24; B64D 13/08; H01M 10/613; H01M 10/625; H01M 2/12

(52) U.S. Cl. CPC H01M 10/6566; B64D 27/24; B64D 13/08; H01M 2220/20; H01M 10/625; H01M 2/1264; H01M 10/613

(57) ABSTRACT

A cooling and venting system is disclosed. The system includes an airflow path through an aircraft, configured to accommodate a battery and allow airflow through the aircraft. In some embodiments, a battery pack that has openings for airflow is placed in the airflow path.

### BACKGROUND OF THE INVENTION

Battery systems used to power electric airplanes may require active cooling. In the event of cell thermal runaway, the batteries may produce hazardous gases that must be expelled from the aircraft. Electric aircraft may require a solution that prioritizes pilot safety and efficiency of the aircraft.

### BRIEF DESCRIPTION OF THE DRAWINGS

Various embodiments of the invention are disclosed in the following detailed description and the accompanying drawings.

FIG. 1 is a diagram illustrating an embodiment of an integrated cooling and venting system.

FIG. 2A is a diagram illustrating an embodiment of an integrated cooling and venting system.

FIG. 2B is a diagram illustrating an embodiment of an integrated cooling and venting system comprising multiple batteries.

FIG. 2C is a diagram illustrating an embodiment of an integrated cooling and venting system comprising staggered batteries.

FIG. 3 is a diagram illustrating an embodiment of an airflow path.

FIG. 4 is a diagram illustrating an embodiment of an integrated cooling and venting system comprising a center chamber.

FIG. 5 is a diagram illustrating an embodiment of an integrated cooling and venting system comprising a center chamber.

FIG. 6 is a diagram illustrating an embodiment of a horizontally oriented airflow path.

FIG. 7 is a diagram illustrating an embodiment of an integrated cooling and venting system.

FIG. 8A is a diagram illustrating an embodiment of an air outlet.

FIG. 8B is a diagram illustrating an embodiment of a louvered air outlet.

FIG. 9A is a diagram illustrating an embodiment of an inlet.

FIG. 9B is a diagram illustrating an embodiment of an aircraft comprising inlets.

FIG. 10 is a diagram illustrating an embodiment of a battery pack.

FIG. 11 is a diagram illustrating an embodiment of airflow through a battery pack.

FIG. 12 is a diagram illustrating an embodiment of battery vents.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An integrated cooling and venting system is disclosed. The cooling and venting system comprises an airflow path through an aircraft, configured to allow airflow through the aircraft. The airflow path is configured to accommodate a battery. The system further comprises an inlet positioned at a first end of the airflow path and an outlet positioned at a second end of the airflow path. The airflow path may comprise a continuous, unobstructed upward slope from the battery to the outlet.

An electric aircraft may stow one or more batteries used to power the aircraft. The batteries may create heat and require cooling in order to maintain optimal function. In some instances, the batteries may create undesired products that must be expelled from the aircraft. The batteries may be contained in an airflow path which travels through the aircraft. The path may be self-contained from the rest of the aircraft, allowing a safe channel for undesired products to escape the aircraft. Air may flow in from outside the aircraft and through the airflow path, cooling the batteries.

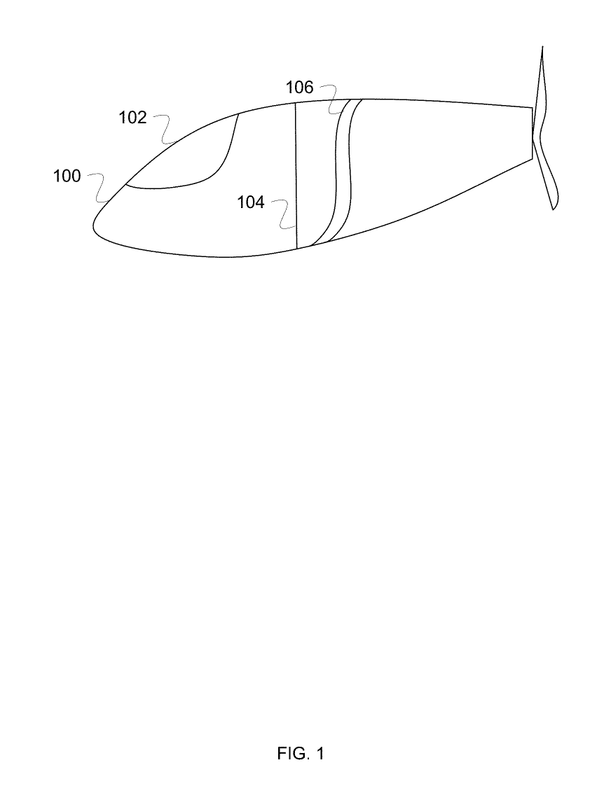

FIG. 1 is a diagram illustrating an embodiment of an integrated cooling and venting system. In the example shown, aircraft 100 comprises airflow path 106. Path 106 may comprise a channel or pipe that traverses the aircraft. The path may be fully enclosed or sealed. For example, the path may be airtight and watertight. Path 106 may connect two openings in the aircraft, allowing air to flow through the aircraft. As shown, path 106 follows a largely vertical path with a slight bend towards the tail end of the aircraft. Air may enter from underneath the aircraft, flow through the path, and exit from the top of the aircraft. The air may flow in a direction opposite the direction of flight of the aircraft.

The integrated cooling and venting system may be utilized in an electric aircraft. An electric aircraft may require cooling and venting of one or more batteries stored on the aircraft. Batteries may be placed in path 106, allowing air to flow past the batteries and cool them. The airflow may dissipate heat and cause warmed air to be expelled from the aircraft. The system may provide active cooling during steady state flight by blowing forced air on the batteries. In some embodiments, airflow through the path is constant during forward flight. The path may also act as a vent path. The path allows hazardous gases to be expelled from the aircraft. For example, batteries may produce combustible gases such as hydrogen or methane in the event of thermal runaway. The gases may leave the aircraft via path 106. In some embodiments, other components requiring cooling or venting are placed in the airflow path.

In the example shown, path 106 is isolated from cockpit 102. A pilot may be protected from heat, gases, or outside air contained within the path. In some embodiments, fire resistant or nonflammable materials are used in building the path or are used around the path. In the example shown, fire wall 104 divides a front section of the fuselage from a back section of the fuselage, where the airflow path is.

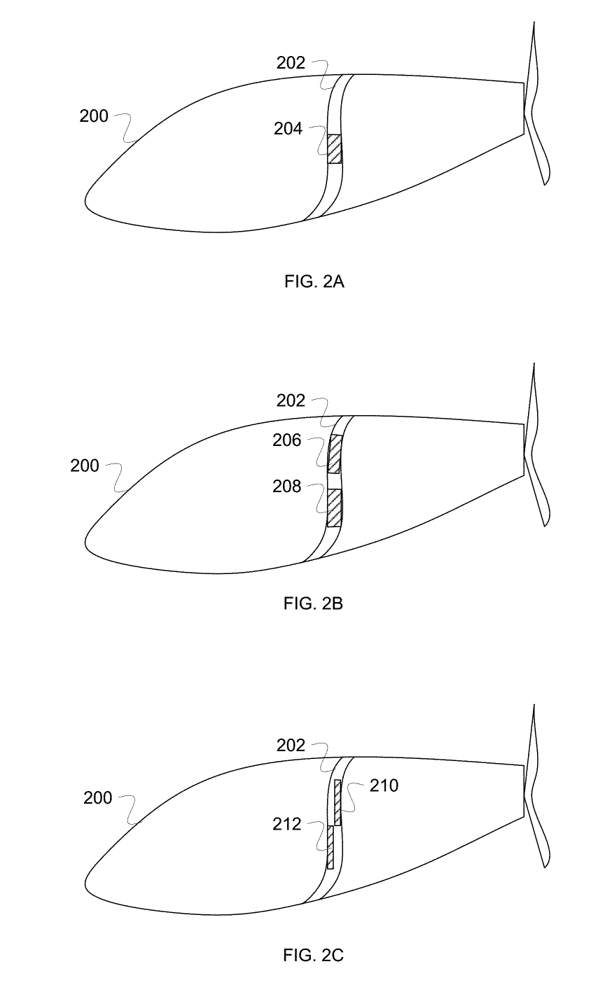

FIG. 2A is a diagram illustrating an embodiment of an integrated cooling and venting system. In the example shown, aircraft 200 comprises airflow path 202. Battery 204 is placed within airflow path 202. In some embodiments, a single battery is placed in the airflow path. The battery may be installed to the inside of the airflow path. The battery may be installed without obstructing the path, allowing air to flow around or over the battery. In some embodiments, multiple batteries are placed within the path. For example, battery 204 may comprise a pack of batteries stored together. The plurality of batteries may be stored in a mount that has gaps, allowing air to flow through the mount and cool the batteries.

FIG. 2B is a diagram illustrating an embodiment of an integrated cooling and venting system comprising multiple batteries. In some embodiments, the multiple batteries are electrically independent. In the example shown, battery 206 and battery 208 are stored within airflow path 202 in aircraft 200. Battery 206 is stored above battery 208 in the airflow path. Batteries 206 and 208 may comprise a single battery or battery packs. In some embodiments, multiple batteries or components to be cooled are stored at different locations in the airflow path. In the example shown, air may enter from the underside of aircraft 200, pass over battery 208, pass over battery 206, and then flow out of the fuselage. In various embodiments, various numbers of batteries or battery packs are cooled by the integrated cooling and venting system.

FIG. 2C is a diagram illustrating an embodiment of an integrated cooling and venting system comprising staggered batteries. In the example shown, battery 210 and battery 212 are stored within airflow path 202 of aircraft 200. Battery 210 is installed on the left side of the airflow path as shown and battery 212 is installed on the right side of the airflow path as shown. In some embodiments, multiple batteries or battery packs stored in the same airflow path are staggered so that warmed air or gases from one battery do not pass through another battery.

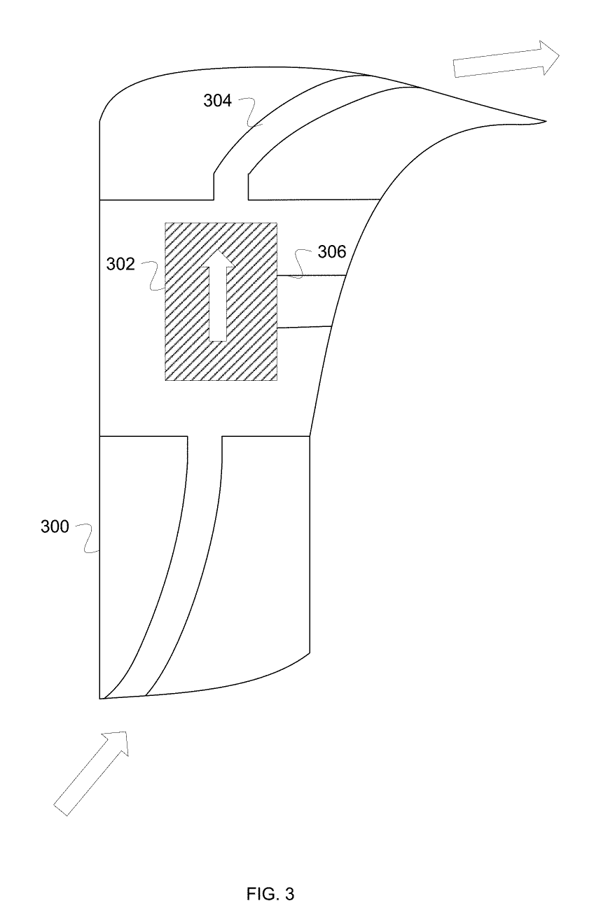

FIG. 3 is a diagram illustrating an embodiment of an airflow path. In various embodiments, the airflow path may be configured or shaped in different ways. In the example shown, airflow path 304 comprises a center chamber in between two thin sections of path. The two thin sections of path may comprise piping. Battery 302 is stored in the center. Battery 302 is attached to mount 306, which is attached to the inside of the airflow path. The mount holds the battery in between the two narrow sections of the airflow path. The entire airflow path is contained within section 300 of the aircraft. Section 300 may comprise an insulator or barrier material, isolating the section from the rest of the aircraft.

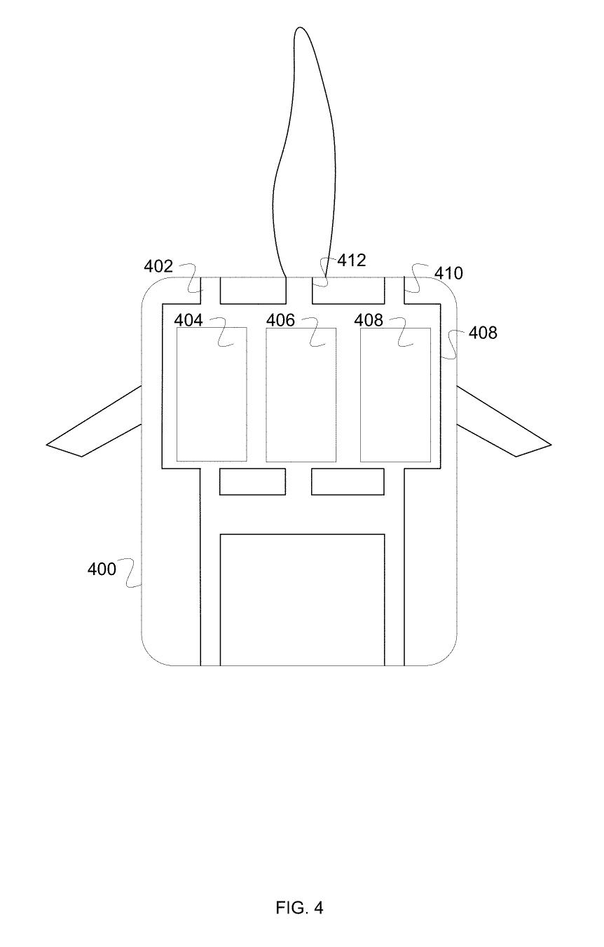

FIG. 4 is a diagram illustrating an embodiment of an integrated cooling and venting system comprising a center chamber. Aircraft 400 is shown from a head-on view (e.g. facing the cockpit). In the example shown, center chamber 408 comprises batteries 404, 406, and 408. Batteries 404, 406, and 408 may comprise battery packs. As shown, air enters two inlets at the bottom of the aircraft. The two inlets are connected by a channel. The three airflow paths are connected to the channel and allow air to flow through the channel to center chamber 408. Air flows out of center chamber 408 through airflow paths 402, 412, and 410. Air passes through center chamber 408 as part of all the airflow paths. As air flows through the airflow paths, the batteries are cooled. Gases produced by the batteries may be expelled via airflow paths 402, 412 and 410. In the example shown, airflow paths 402 and 410 extend from inlet to outlet whereas airflow path 412 extends halfway through the aircraft. Some air that enters airflow paths 402 and 410 flows through airflow path 412. In some embodiments, an airflow path may comprise forks. In various embodiments, one, two, four, or any appropriate number of airflow paths may be used in an aircraft.

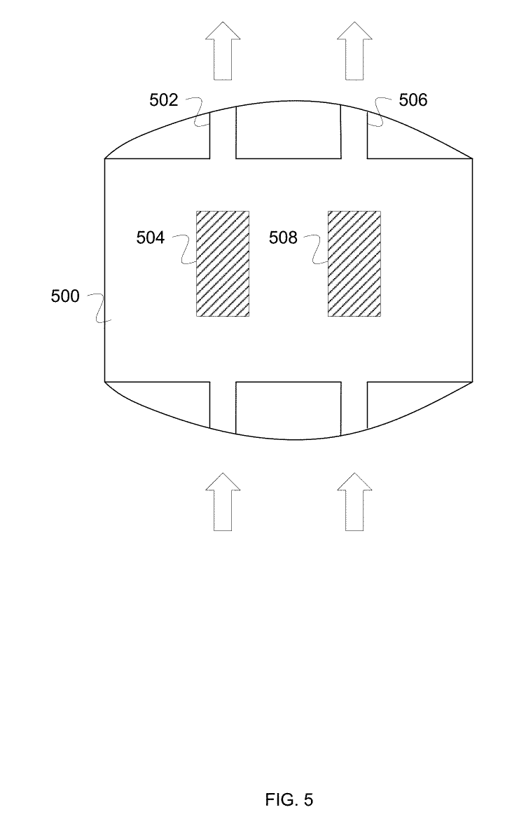

FIG. 5 is a diagram illustrating an embodiment of an integrated cooling and venting system comprising a center chamber. In the example shown, battery 504 and battery 508 are stored inside of center chamber 500. Airflow paths 502 and 506 both pass through and include center chamber 500. In the example shown, batteries 504 and 508 are placed in the direct path of the airflow from the two airflow paths. In various embodiments, the location and placement of the batteries is based on one or more of the following: the shape of the aircraft, the number of batteries, the shape of the airflow path, the number of airflow paths, or the location of the airflow paths in the aircraft.

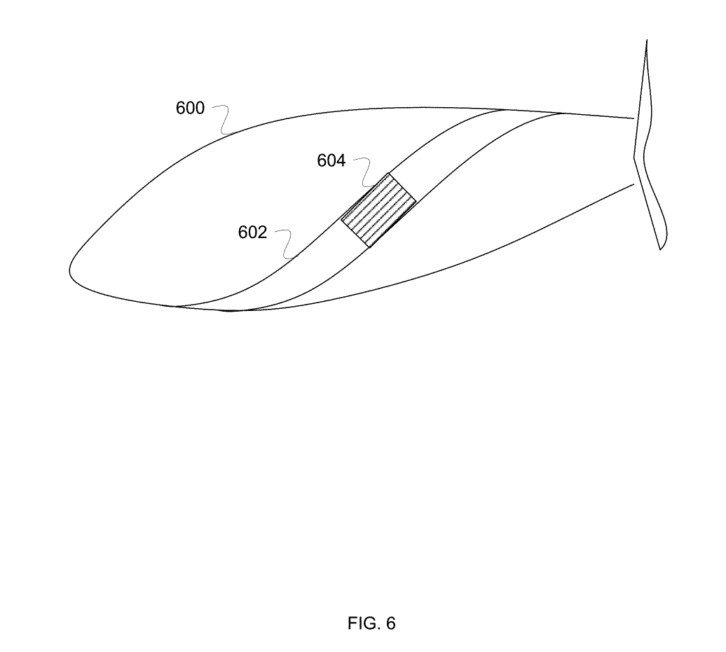

FIG. 6 is a diagram illustrating an embodiment of a horizontally oriented airflow path. In various embodiments, the airflow path is positioned mostly vertically or mostly horizontally. The battery or battery pack stored in the airflow path may be positioned based on the angle of the path. Battery 604 as shown is rotated to fit in airflow path 602. A battery pack structure may be arranged to allow air to flow through gaps or slots in the battery pack structure. In the example shown, airflow path 602 is positioned largely horizontally in aircraft 600. The angle of the path from horizontal is shallow. In some embodiments, the airflow path maintains at least some degree of upwards tilt from its inlet to its outlet. In some embodiments, the airflow path maintains at least some degree of upwards tilt from a location the batteries are stored to the outlet. Typical hazardous gases produced by batteries may be lighter than air. An upwards slope may enable the gases to easily float up and out of the aircraft. The section of the airflow path from the battery to the outlet may allow light gases to float, unobstructed, out of the aircraft. In some embodiments, air in the airflow path flows from a front of the aircraft to a back of the aircraft. Air may rush in as the aircraft flies forward. Expelling air towards the tail end of the aircraft may be advantageous aerodynamically.

In some embodiments, the airflow path may take on shallow angles near its two ends. For example, the ends of the airflow path at the inlet and the outlet as shown are flattened compared to the rest of the path. The ends may be at a shallow angle in order to optimize the amount of air intake or to optimize drag.

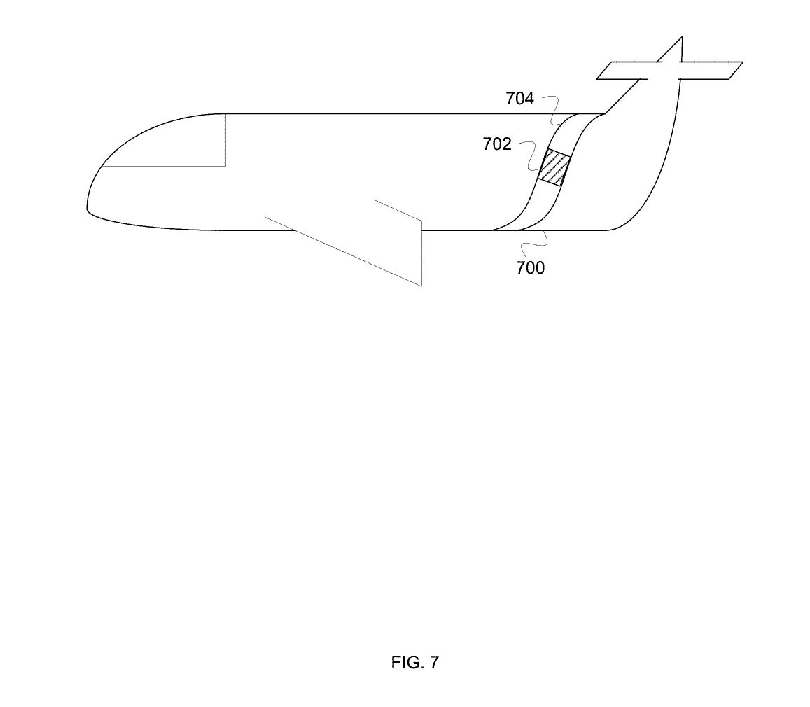

FIG. 7 is a diagram illustrating an embodiment of an integrated cooling and venting system. The system may be used in various aircraft. As shown, battery 702 is stored in airflow path 704 of aircraft 700. Aircraft 700 comprises a standard commercial passenger aircraft configuration. Airflow path 704 is positioned near a tail end of the fuselage. In various embodiments, the airflow path is positioned in various positions on the aircraft.

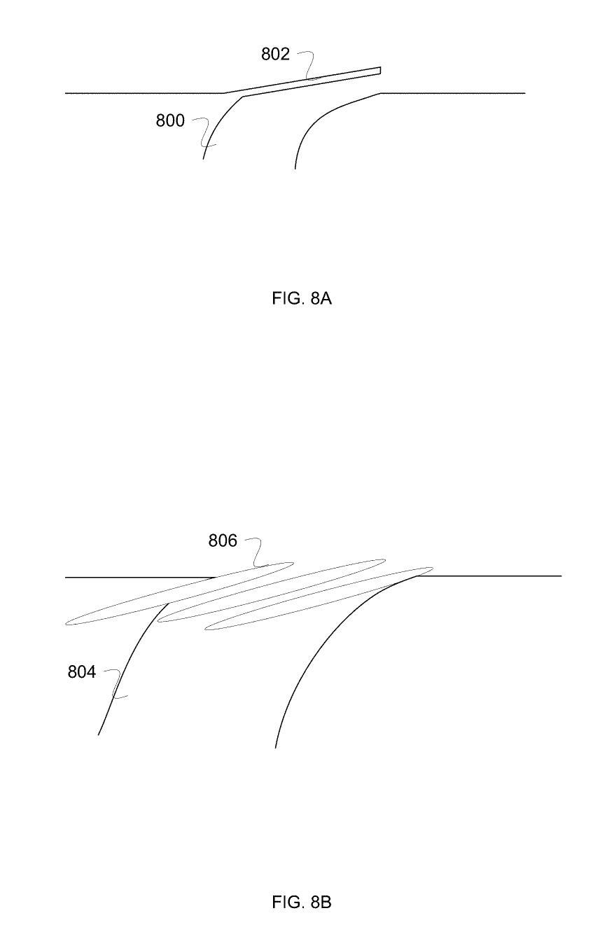

FIG. 8A is a diagram illustrating an embodiment of an air outlet. The air outlet may comprise the end of the airflow path that air is expelled from. In some embodiments, the air outlet has a cover that prevents rain, debris, or any undesired matter from entering the outlet. The cover may be needed in the event the outlet is positioned at the top of the aircraft. In the example shown, flap 802 covers the outlet of airflow path 800. In some embodiments, flap 802 is installed in a fixed position. The flap may protect the airflow path while allowing air to escape. In some embodiments, flap 802 has multiple possible positions. For example, the flap may be manipulated to allow more or less air out.

FIG. 8B is a diagram illustrating an embodiment of a louvered air outlet. Various covers or covering apparatuses may be used at the outlet of the airflow path. In the example shown, slats 806 are installed at the outlet of airflow path 804. The slats may allow air to escape from the aircraft while preventing undesired objects from entering the airflow path.

A cover (e.g. flap, slats, or any other appropriate apparatus) may be positioned based on an aircraft's current conditions. For example, allowing a large amount of air to flow out may increase drag on the aircraft, which is not desirable during forward flight. In some embodiments, the cover may be controlled automatically using mechanical or electrical means. The cover may be controlled based on an aircraft's position or flight trajectory. The cover position may be changed based on a pilot indication. The cover position may be changed manually (e.g. between flights).

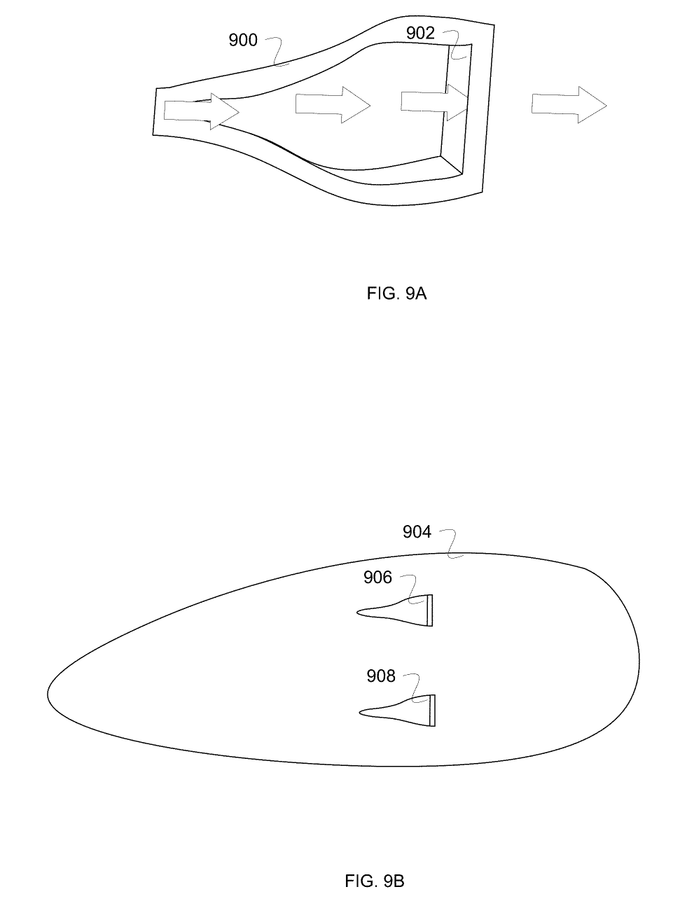

FIG. 9A is a diagram illustrating an embodiment of an inlet. The inlet may comprise the end of the airflow path that air enters from. In some embodiments, a National Advisory Committee for Aeronautics (NACA) inlet is utilized. The inlet may comprise a depression that is shallow and gradually deepens into an opening. In the example shown, air enters from a tapered end of the inlet and enters opening 902 of the inlet. The inlet may comprise a shallow depression at its tapered end that deepens, reaching its deepest point at opening 902. Opening 902 may attach to an airflow path. The inlet may be shaped to effectively funnel air into the airflow path.

FIG. 9B is a diagram illustrating an embodiment of an aircraft comprising inlets. Aircraft 904 is shown from below. The underside of aircraft 904 comprises inlets 906 and 908. The narrow end of the inlets as shown are positioned closer to the nose of the aircraft.

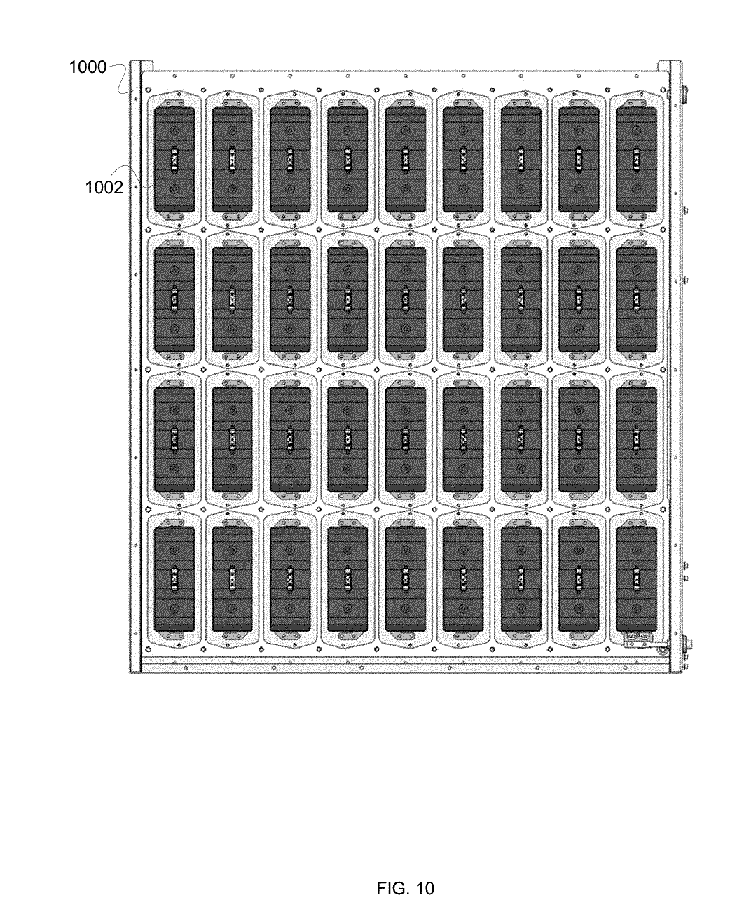

FIG. 10 is a diagram illustrating an embodiment of a battery pack. In the example shown, a multitude of batteries are stored in pack structure 1000. Pack structure 1000 may comprise a frame made to hold batteries. Pack structure 1000 may comprise fiberglass, aluminum, or any appropriate materials. As shown, battery 1002 is stored in the pack structure along with 35 other batteries.

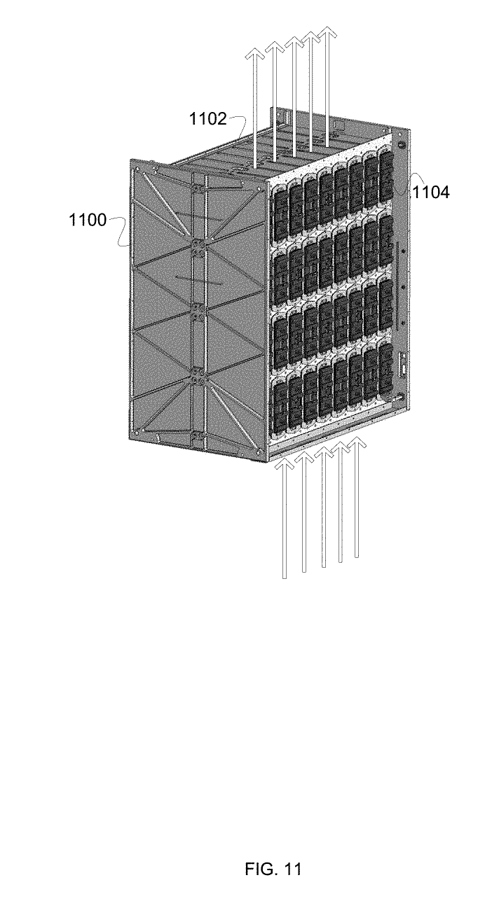

FIG. 11 is a diagram illustrating an embodiment of airflow through a battery pack. In some embodiments, multiple batteries are stored in a pack structure that comprises openings in it that allow air to flow through the pack structure. In the example shown, pack structure 1100 comprises slit 1102 and a plurality of other slits. The slits may run through the entirety of the pack structure. The slits as shown are positioned in between the columns of batteries. The slits may enable each individual battery stored in the pack structure to be exposed to airflow. As shown, battery 1104 and 35 other batteries are stored in the front of pack structure 1100. An additional 36 batteries may be stored in the back side of the pack structure. As shown, two rows of slits are present in the pack structure, allowing air to flow over the batteries stored in the front of the pack structure and batteries stored in the back of the pack structure. In various embodiments, 20, 72, 100, or any appropriate number of batteries may be stored in a single pack structure.

The pack structure may be attached to an inner wall of an airflow path. The pack structure may be installed such that air flows through the openings of the pack structure.

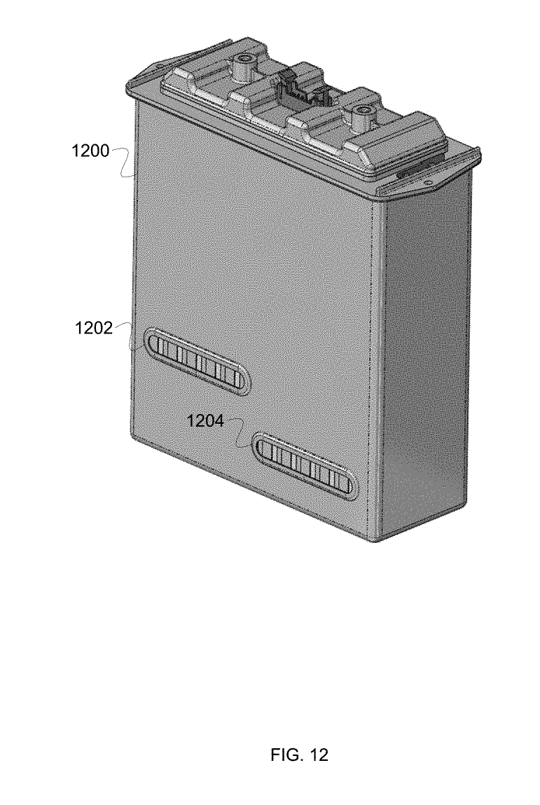

FIG. 12 is a diagram illustrating an embodiment of battery vents. In some embodiments, a battery used in an integrated cooling and venting system comprises one or more vents holes in its case. The vent hole may be covered with a thin material. In the event of thermal runaway, the thin material over the vent hole may be compromised, allowing dangerous gases to escape via the vent hole. The gases may be expelled from the aircraft via the airflow path.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A cooling and venting system, comprising:
an airflow path through an aircraft, configured to accommodate a battery and allow airflow through the aircraft;
an inlet positioned at a first end of the airflow path; and
an outlet positioned at a second end of the airflow path.

2. The system of claim 1, wherein the airflow path comprises a continuous, unobstructed upward slope from the battery to the outlet.

3. The system of claim 1, wherein gas created by the battery is expelled from the aircraft through the airflow path.

4. The system of claim 1, wherein airflow through the airflow path cools the battery.

5. The system of claim 1, wherein a battery pack structure storing multiple batteries is placed in the airflow path.

6. The system of claim 5, wherein the battery pack structure comprises openings through the battery pack structure.

7. The system of claim 6, wherein the openings are configured to allow airflow to pass over each battery stored in the battery pack structure.

8. The system of claim 1, wherein the airflow path comprises a fully sealed path through the aircraft.

9. The system of claim 1, wherein fire-resistant materials are used to isolate the airflow path from other areas of the aircraft.

10. The system of claim 1, wherein air enters the inlet, travels through the airflow path, and exits the outlet.

11. The system of claim 1, wherein the inlet is positioned on the underside of the aircraft.

12. The system of claim 1, wherein the outlet is positioned on the top of the aircraft.

13. The system of claim 1, wherein the airflow path crosses through a fuselage of the aircraft.

14. The system of claim 1, wherein the airflow path is angled with the outlet positioned higher on the aircraft than the inlet.

15. The system of claim 1, wherein the airflow path is more shallowly angled at its two ends than at a center section of the airflow path.

16. The system of claim 1, wherein one or more additional airflow paths are used in the electric aircraft.

17. The system of claim 16, wherein the airflow path and the one or more additional airflow paths pass through a shared chamber.

18. The system of claim 17, wherein the battery is stored in the shared chamber.

19. The system of claim 1, wherein the inlet is a National Advisory Committee for Aeronautics inlet.

20. The system of claim 1, wherein the outlet is louvered.
